(19) United States
(12) Patent Application Publication
(10) Pub. No.: US 2007/0132268 A1
(43) Pub. Date: Jun. 14, 2007

(54) Electric tarping system

(76) Inventor: Robert Bromberek, Lemont, IL (US)

Correspondence Address: Andreou & Casson, Ltd., 661 West Lake Street, Suite 2 North, Chicago, IL, 60661-1034, US

(21) Appl. No.: 11/292,891

(22) Filed: Dec. 3, 2005

(51) Int. Cl. B60J 11/00

(52) U.S. Cl. 296/98

(57) ABSTRACT

An electric tarping system for covering open transport containers comprising a tarp, an electric lift with moveable framework, and an electric motor. The electric lift raises or lowers to provide the tarp with the necessary height needed to adequately cover the open transport container. Once the height is reached, the tarp is either rolled or unrolled to cover or uncover the transport container.

### FIELD OF THE INVENTION

This invention relates to an electric tarping system for a transport container on a motor vehicle.

### BACKGROUND OF THE INVENTION

Transport containers, especially those used on trucks to haul large loads, are typically open at the top. Having an open top makes the transport container easier to fill. While these open transport containers are easy to fill, they are also prone to losing part of the load while in transport. Debris can escape causing possible damage or injury to other vehicles. As a result, transport containers must be covered to ensure safe travel while in route.

A typical solution to the problem of open transport containers is to cover the opening with a tarp. Sometimes a user will manually cover the transport container using a system of fasteners, ropes, and other ties. All of the ties must be physically tightened by the user ensuring a secure load. This manual process can be very difficult and labor intensive for the user while also being extremely time consuming and potentially dangerous. As a result, users have demanded mechanical and safer systems to cover transport containers.

To meet this demand, consumers have been given automatic systems that utilize mechanical arms that extend or retract over the loads on transport containers. As the arms extend or retract, the tarp is unrolled or rolled over the transport container. These arms can be telescopic or may comprise joints to move over the opening of the transport container. While these automatic systems have been extremely helpful to consumers, they have also been plagued with problems. Such problems include an extremely labor intensive method of fitting trucks with such systems. Once the systems are fitted to vehicles, repair can be costly and time consuming as the arms are prone to damage. The arms must be maintained so that they continue to move freely over the transport container. The arms are exposed to the potentially destructive elements of travel such as adverse weather, salt, dirt, debris, water, temperature, etc. All of these elements can cause potential damage affecting the movement of the arms. Any damage must be repaired so that the system continues to work safely and effectively. As a result of the problems commonly encountered, systems, like that in U.S. Pat. No. 6,347,826B1, have been developed to remove the arms from the tarping process.

These armless tarping systems are hydraulic systems which raise or lower a tower to a desired height using hydraulics. Once the height is achieved a tarp can be pulled over the load in the transport container. While these systems are effective in aiding a user of the open transport container, hydraulic systems can also encounter their own set of problems. Hydraulic systems are dependant on the pressure transmitted or resistance offered being able to handle the load it is designed to move. If any part of the hydraulic system is damaged or otherwise non-functional, the tarping system will not perform as expected. The pressure will not be high enough to maintain movement of the tarping system as it is designed to do or the system will cease function completely. Parts protrude out from the system and can be damaged because, they, like the systems with arms are often exposed to adverse travel elements.

Vehicles hauling large loads must meet certain weight restrictions. Hydraulic systems tend to be heavy and users are simply demanding lighter systems so that larger loads can be hauled. This invention helps to meet the user's demands by solving many of the commons problems discussed above by utilizing an electric, armless system.

### SUMMARY OF THE INVENTION

This invention addresses the above-mentioned problems by providing an electric system that is easier to install and easier to repair then a hydraulic, armless tarping system. This electric tarping system provides all the safety of an automatic tarping system without the problems that typical hydraulic tarping systems encounter.

The battle over electrics versus hydraulics has been generally debated for a long time. However, in many devices, an electric system is simply not feasible yet. Hydraulic systems continue to be used because a functional electric system simply has not been designed to perform as well as the existing hydraulic systems. This is no longer the case in the transport container tarping industry. This invention has developed an electric tarping system that not only rivals the existing hydraulic methods, but provides a better solution to users tarping needs.

This electric tarping system provides many advantages to the tarping industry and to the users who maintain the systems. An electric system is more streamlined with no protruding parts open to the adverse elements of travel. An electric system also allows users a reduced risk of the system being influenced by external temperature changes and a lower risk for safety concerns in the event that a part malfunctions due to an external force. Electric systems simply perform as the user desires so long as there is a power supply and there is no inertia to be compensated for on movements. Hydraulic systems simply cannot perform as easily as an electric system to achieve desired results simply based on their basic nature of function and design. The benefits of an electric system allow user a simply easier and better way to maintain tarping systems on a transport vehicle. A user has reduced number of spare parts to maintain and it is easier to train users how to fix any problems then on a hydraulic system. This invention provides an ideal situation for users of a tarping system; it provides a way of covering transport containers that is completely self-contained and not dependant on external services other then input electrical power.

This invention can easily be made to varying sizes and to fit behind differing vehicle cabs. If a vehicle has special limitations, then this invention can be made to fit any requirement. It can be fitted to a mount on the side of a vehicle or onto the body of the vehicle. This invention may also be without a cross-member between the two columns of the tower. This allows a driver of the vehicle an uninhibited view behind the cab with no additional obstructions.

Some embodiments may also utilize a limit switch to start and stop at pre-set positions. This also for added safety by ensuring the system will not over-run its desired heights possibly causing injury to property or the user.

Each of the columns in this invention have lifting and lowering capabilities. This ensures that each side will lift and lower in unison ensuring that the tarp remains level at all times.

Other advantages and aspects of the present invention will become apparent upon reading the following description of the drawings and the detailed description of the invention.

### BRIEF DESCRIPTION OF THE DRAWINGS

FIG. 1 depicts a full view of the electric tarping system on a vehicle with an open transport container.

FIG. 2 depicts a detailed view of the electric tarping system as seen behind the cab of a vehicle.

FIG. 3 depicts a detailed view of the movable framework.

FIG. 4 depicts a detailed view of the tarp and moveable framework.

### DETAILED DESCRIPTION OF THE PREFERRED EMBODIMENT

While this invention is prone to embodiments in many differing forms, preferred embodiments of this invention with the understanding of the present disclosure is to be considered as an exemplification of the principles of the invention and is not intended to limit the broad aspect of the invention the embodiments illustrated.

This invention relates to an electric tarping system for a transport container 2 on a vehicle 4 comprising a tarp 6 capable of being unrolled to cover the transport container 2 or rolled to uncover the transport container 2, an electric lift 8 further comprising movable framework 10 and an electric motor 12 connected to the battery of the vehicle 4 supplying power to the electric lift 8.

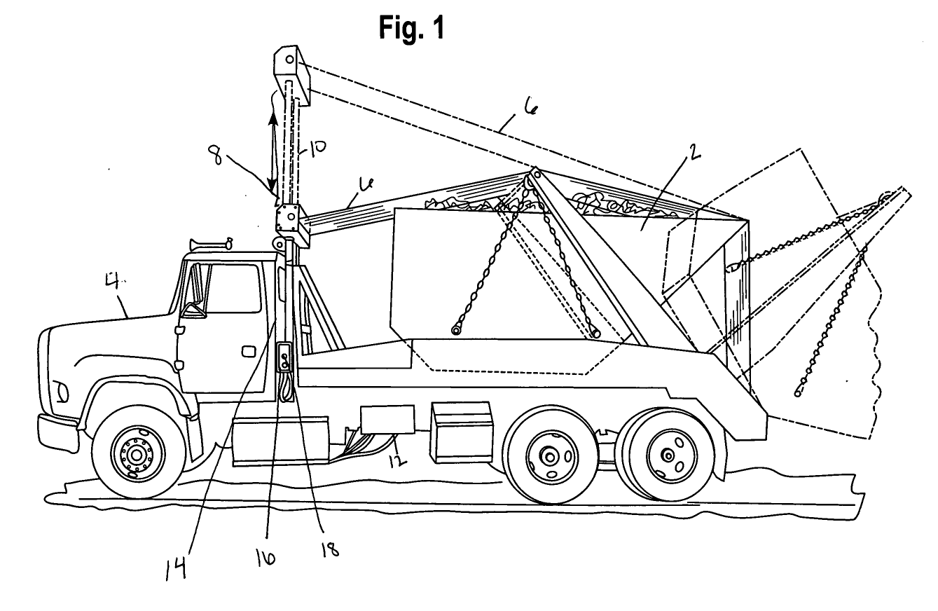

A vehicle utilizing an open transport container 2 as seen in FIG. 1 is fitted with the electric tarping system in a position most suited to its use. Such a position is generally behind the vehicle cab 14 and in front of the transport container 2. FIG. 2 depicts this position in detail. The electric motor 12 further comprises a control unit 16 to allow a user to power the electric lift 8.

When a user desires to cover the open transport container 2, he/she simply needs to use buttons 18 on the control unit 16. With a simple push of a button 18, the electric lift 8 is activated. Since the electric lift 8 is powered by the vehicle battery (not shown), no external power source is needed. The electric lift 8 comprising of an electric motor 12 and movable framework 10 raises to the user's desired height. When that height is reached, the user stops movement by using the buttons 18 on the control unit 16. Once the height is reached, the tarp 6 can be unrolled and secured to cover the opening of the transport container 2. Once the tarp 6 is covering the transport container 2, the electric lift 8 can be further adjusted in height to ensure covering of the open transport container 2.

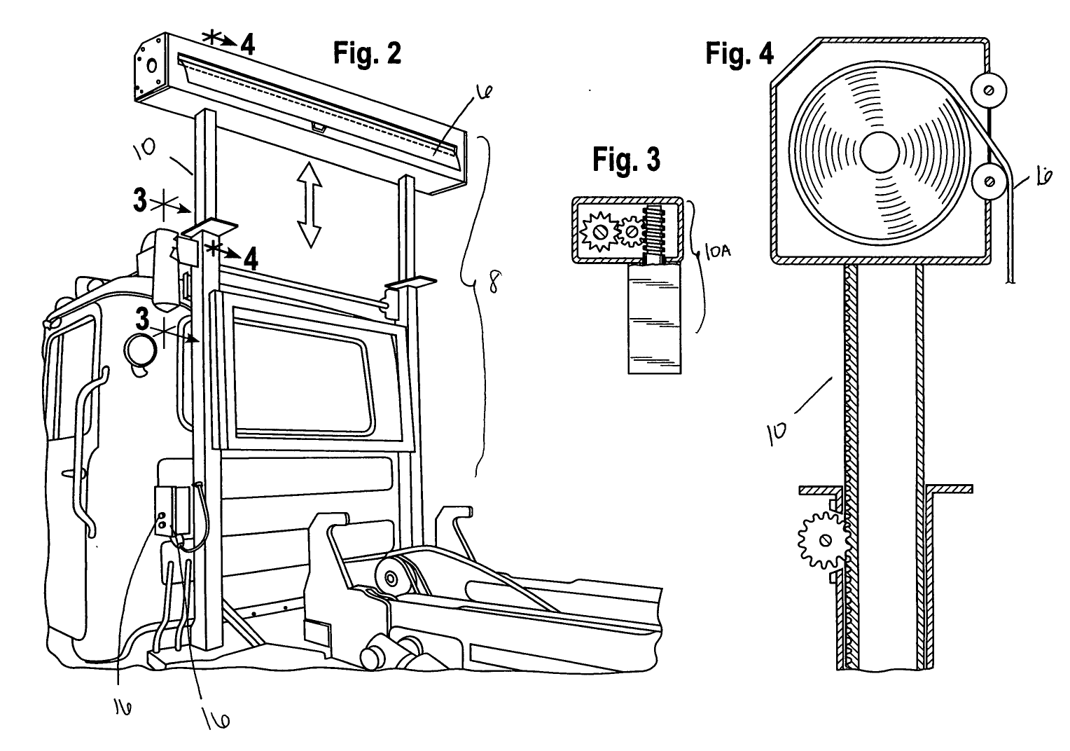

To uncover the transport container 2, a user simply needs to roll the tarp 6 back to its stored position as seen in FIG. 2 and then use the buttons 18 on the control unit 16 to lower the movable framework of the electric lift to a desired lowered height. Detail views of the moveable framework 10 and tarp 6 are seen in FIGS. 3-4.

In its preferred embodiment, the electric lift 8 should be able to move the moveable framework 10 and tarp 6 to any height desired to cover a transport container 2 of any size. This electric tarping system is versatile so that it is not limited to working with any one type of transport container 2.

Embodiments of this invention may also comprise safety guards to protect users against injury through use of this tarping system. This tarping system can also be reinforced at the points of attachment on the transport container 2 depending on a users needs.

The above explanation supports the preferred embodiment of the present invention. Other embodiments, including those with changes, may be made without losing aspects of this invention.

1. An electric tarping system for a cargo container on a vehicle comprising:
an electric lift comprising moveable framework raising or lowering a tarp to desired heights for said container; and
an electric motor consisting a vertical drive mechanism connected to vehicle battery supplying power to said electronic lift.

2. An electric tarping system as in claim 1 wherein said electric lift and said tarp are in a position between the vehicle cab and said container.

3. An electric tarping system as in claim 1 wherein said electric lift further comprises a control unit positioned in as easily accessible location for the user.

4. An electric tarping system as in claim 3 wherein said control unit comprises controls for raising or lowering said moveable framework of said electric lift to desired heights.

5. (canceled)
